(19) United States
(12) Patent Application Publication
(10) Pub. No.: US 2023/0304847 A1
(43) Pub. Date: Sep. 28, 2023

(54) GRIPPING SYSTEM, GRIPPING METHOD, AND STORAGE MEDIUM

(71) Applicant: CONNECTED ROBOTICS, INC., Tokyo (JP)

(72) Inventors: Koichi TSUKAMOTO, Tokyo (JP); Wing Sum LO, Tokyo (JP); Thomas KILLUS, Tokyo (JP); Suraj PRAKASH PATTAR, Tokyo (JP)

(73) Assignee: CONNECTED ROBOTICS, INC., Tokyo (JP)

(21) Appl. No.: 18/099,057

(22) Filed: Jan. 19, 2023

(30) Foreign Application Priority Data
Mar. 25, 2022 (JP) 2022-050949

(51) Int. Cl. G01G 19/52; B25J 11/00

(52) U.S. Cl. CPC G01G 19/52; B25J 11/0045

(57) ABSTRACT

A portioning system includes a foodstuff supply unit, a multi-joint robot, and a control device. The multi-joint robot gripes an object that is a gripping object. The control device controls an action of the multi-joint robot. The multi-joint robot, under control of the control device, inserts a gripping member included in a hand of the multi-joint robot into the object, from a surface of the object to a depth at which a physical quantity of the object is estimated to be a predetermined amount, and grips the object.

### CROSS-REFERENCE TO RELATED APPLICATIONS

This application is based upon and claims the benefit of priority under 35 USC 119 of Japanese Patent Application No. 2022-50949 filed on Oct. 5 2021 the entire disclosure of which, including the description, claims, drawings, and abstract, is incorporated herein by reference in its entirety.

### BACKGROUND OF THE INVENTION

### Field of the Invention

The present invention relates to a gripping system, a gripping method, and a storage medium.

### Description of the Related Art

In recent years, robots have come to be used in work for portioning out foodstuffs, such as work of packing food in packed meals.

For example, in a case in which a robot performs work of packing food in packed meals, actions of the robot gripping a predetermined amount of a foodstuff stored in a container such as a vat or the like, transporting the foodstuff to a predetermined region in the packed meal, and releasing the foodstuff, are repeatedly performed.

### BRIEF SUMMARY OF THE INVENTION

A gripping system according to an aspect of the present invention comprising:
a robot that grips an object, which is a gripping object; and
a control device that controls an action of the robot,
wherein
the robot, under control of the control device, inserts a gripping member included in a hand of the robot into the object, from a surface of the object to a depth at which a physical quantity of the object is estimated to be a predetermined amount, and grips the object.

### BRIEF DESCRIPTION OF THE SEVERAL VIEWS OF THE DRAWING

FIG. 1 is a perspective view illustrating a state in which a plurality of portioning systems 1 according to the present invention are arrayed.

FIG. 2 is a perspective view illustrating principal portions of the portioning system 1 according to the present invention in an enlarged manner.

FIG. 3 is a schematic diagram illustrating an example of a form of a gripping member 31a that is installed on a distal end of the hand 31.

FIG. 4 is a schematic diagram illustrating a hardware configuration of the control device 40.

FIG. 5 is a block diagram illustrating the functional configuration of the control device 40.

FIG. 6 is a schematic diagram illustrating an example of the state of foodstuff in the foodstuff container.

FIG. 7 is a schematic diagram illustrating a concept of the leveling action.

FIG. 8 is a schematic diagram illustrating a concept of the scraping action.

FIG. 9 is a schematic diagram illustrating an example of the gripping action performed by the hand 31.

FIG. 10 is a flowchart showing the flow of foodstuff portioning processing executed by the portioning system 1.

FIGS. 11A to 11C are schematic diagrams illustrating an example of another form of leveling action.

### DETAILED DESCRIPTION OF THE INVENTION

Embodiments of the present invention will be described below with reference to the drawings.

### First Embodiment

### [Configuration]

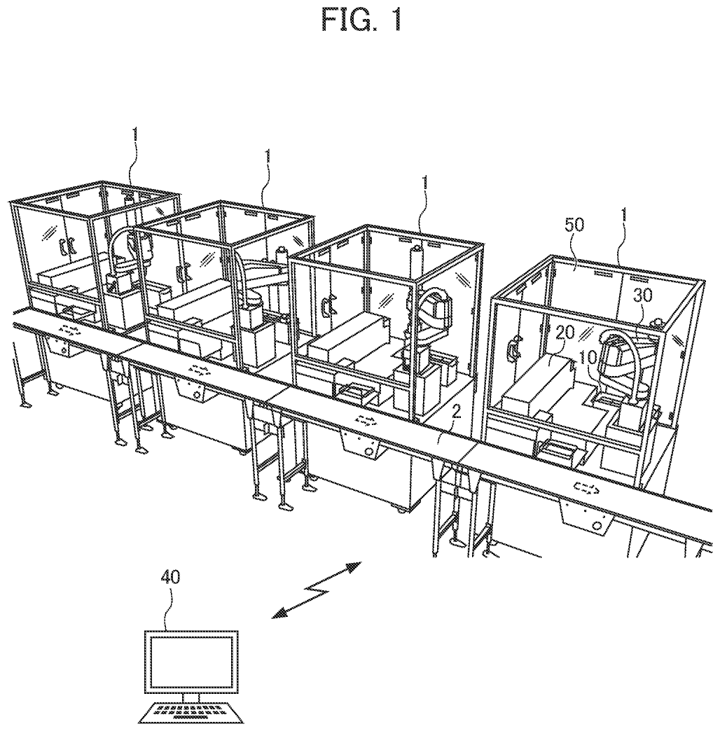

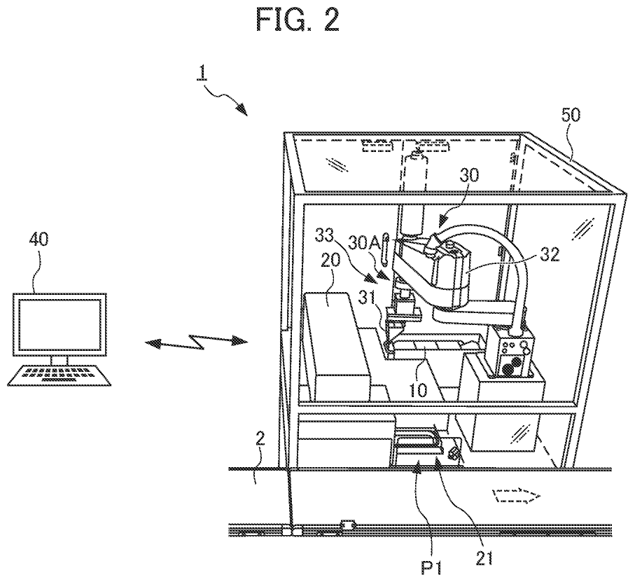

FIGS. 1 and 2 are schematic diagrams illustrating a configuration of an entirety of a portioning system 1 according to the present invention. FIG. 1 is a perspective view illustrating a state in which a plurality of portioning systems 1 are arrayed, and FIG. 2 is a perspective view illustrating principal portions of the portioning system 1 in an enlarged manner.

The portioning system 1 according to the present embodiment illustrates an example of applying the present invention to a system for portioning out materials. In the following description, an example will be described regarding a case of the portioning system 1 gripping prepared foods (foodstuffs) to be packed in packed meals and portioning out into containers for packed meals. Note that while description will be made regarding an example of weight being used as the amount of foodstuffs to be packed, the present invention is not limited to weight, and can be applied to physical quantities of various designations, such as volume, bulk, mass, and so forth.

As illustrated in FIGS. 1 and 2, the portioning system 1 includes a foodstuff supply unit 10, a container supply unit 20, a multi-joint robot 30, a control device 40, and a shielding portion 50. Note that a conveyer belt 2 that automatically conveys containers for packed meals is installed adjacent to the portioning systems 1.

The foodstuff supply unit 10 includes a foodstuff container in which is accommodated the prepared food (foodstuff) to be portioned out in the portioning system 1. A large-sized vat, tray, or the like, for example, can be used as the foodstuff container. Examples of prepared food accommodated in the foodstuff supply unit 10 include salads of paste-like consistency such as potato salad or the like (salads containing foodstuffs with viscosity and tackiness), mashed potatoes, carrot salad, pickled vegetables, braised greens, baked beans, buttered corn, and so forth. In the present embodiment, the foodstuff supply unit 10 accommodates a plurality of servings (e.g., several dozen to several hundred servings) of one type of foodstuff. Accordingly, the plurality of portioning systems 1, each packing a different foodstuff into a single container for a packed meal, enables the work of packing the packed meal to be completed. The foodstuff container of the foodstuff supply unit 10 can be replaced by manual work by a worker, or automatically by the multi-joint robot 30.

The container supply unit 20 supplies containers for packed meals to a predetermined position in the portioning system 1 at which the foodstuff is packed (packing position P1 in FIG. 2. A plurality of the containers for packed meals are accommodated in the container supply unit 20 and the containers are supplied to the packing position P1, one at a time, upon the portioning system 1 beginning actions. Also, a weight sensor 21 that measures the weight of the container for the packed meal is installed at the packing position P1, and upon the foodstuff being packed at the packing position P1, the weight sensor 21 measures the weight of the foodstuff that is packed (i.e., the increase in weight due to the packing). Data of the weight measured at this time is output to the control device 40. Upon the measurement of the weight ending, the container for the packed meal is then discharged to the conveyer belt 2 by a thrusting mechanism included in the container supply unit 20.

The multi-joint robot 30 may be made up of a Selective Compliance Assembly Robot Arm (SCARA), an articulated robot, or the like, and includes a hand 31 that is capable of gripping the foodstuff to be packed, a robot arm 32 that moves the hand 31 to an optional position within a range of movement, and an image-capturing device 33 that shoots images of the vicinity of the hand 31.

Also, a weight sensor 30A that measures the weight of the foodstuff that is gripped is installed in a joint that holds the hand 31 of the multi-joint robot 30, as an example of a unit that acquires the physical quantity of the foodstuff that is gripped by the hand 31. Data of the weight of the foodstuff measured by the weight sensor 30A (i.e., the weight of the foodstuff that is gripped) is output to the control device 40. Further, the joint that holds the hand 31 includes a shaft that rotates the hand 31 in a twisting direction as to the robot arm 32. Accordingly, the orientation of the hand 31 can be changed at the time of the hand 31 gripping the foodstuff, thereby adjusting the direction in which the hand 31 opens and closes. Thus, the orientation of the hand 31 can be changed so as to open and close in a direction parallel to an inner partition of the container when the hand 31 reaches the inner partition of the container, and foodstuff nearby the inner partition of the container can be gripped more readily.

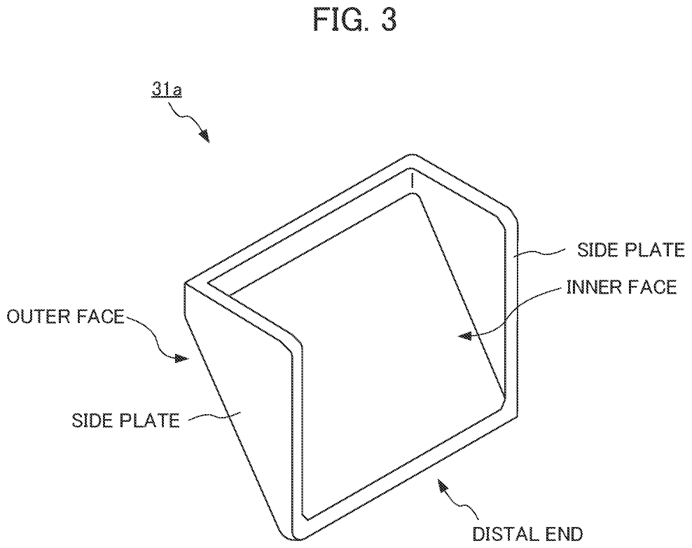

FIG. 3 is a schematic diagram illustrating an example of a form of a gripping member 31a that is installed on a distal end of the hand 31.

Note that a pair of the gripping members 31a is used, and only one thereof is illustrated in FIG. 3.

As illustrated in FIG. 3, in the present embodiment, a gripping member 31a that has a form in which side plates are disposed on the right and left sides of a plate-like member of which a distal end is flat (i.e., a flat plate of which the distal end has a linear edge portion) is used. Accordingly, in the form of the gripping member 31a illustrated in FIG. 3, the hand 31 closes the pair of gripping members 31a so that the gripping members 31a come into contact with each other, thereby forming a container-like structure in which at least lower portions and side portions are closed.

In a case of the form of the gripping member 31a such as described above, perpendicularly inserting the distal ends of the gripping members 31a into a surface of a foodstuff such as a salad of paste-like consistency, closing the pair of gripping members 31a at a predetermined depth, and lifting the foodstuff up, enables a substantially constant amount of foodstuff to be taken out.

Also, the distal end of the gripping member 31a is flat (a form in which the distal end has a linear edge portion), an outer face is planar, and the edge portion is disposed so as to be parallel to a bottom face of the foodstuff container. Accordingly, the gripping member 31a illustrated in FIG. 3 has a form that is suitable for a leveling action (action of flattening the surface of the foodstuff), which will be described later, and also can be installed in an arrangement that facilitates the leveling action.

Returning to the description of FIGS. 1 and 2, the image-capturing device 33 of the multi-joint robot 30 successively shoots images of a shooting-object site including images of the vicinity of the hand 31, in a process of taking foodstuff out from the foodstuff supply unit 10 and a process of packing the foodstuff that is taken out in the container for the packed meal. Data of images shot at this time is output to the control device 40. Note that an image-capturing device that is capable of shooting the operation range of the multi-joint robot 30 may be installed at a predetermined location of the portioning system 1, instead of the image-capturing device 33 or in addition to the image-capturing device 33, and images of the shooting-object site including the vicinity of the hand 31 may be shot by this image-capturing device. Also, the image-capturing device installed in the portioning system 1, such as the image-capturing device 33 or the like, may be an arrangement capable of acquiring three-dimensional forms, such as a stereo camera or the like. Note however that a three-dimensional form of a subject can be calculated on the basis of two two-dimensional images acquired by changing shooting positions of an image-capturing device that shoots two-dimensional images.

The control device 40 is made up of an information processing device such as a personal computer (PC), a programmable controller, or the like, and controls the overall portioning system 1 by executing various types of programs. For example, the control device 40 controls actions of the container supply unit 20 supplying containers, actions of the multi-joint robot 30 gripping and packing the foodstuff, and so forth.

The shielding portion 50 is made up of plate-like members that surround around and above a region in which the foodstuff supply unit 10, the container supply unit 20, and the multi-joint robot 30 are installed, in the portioning system 1. The plate-like members making up the shielding portion 50 are made of a transparent material such as glass, resin, or the like, so that the state of operation of the portioning system 1 can be externally viewed. Also, a door that is capable of being opened and closed is disposed in part of a side wall making up the shielding portion 50. In a case of replacing the foodstuff container of the foodstuff supply unit 10, adding containers to the container supply unit 20, performing maintenance of the portioning system 1, or the like, a door of the shielding portion 50 can be opened to perform various types of work.

### [Hardware Configuration of Control Device 40]

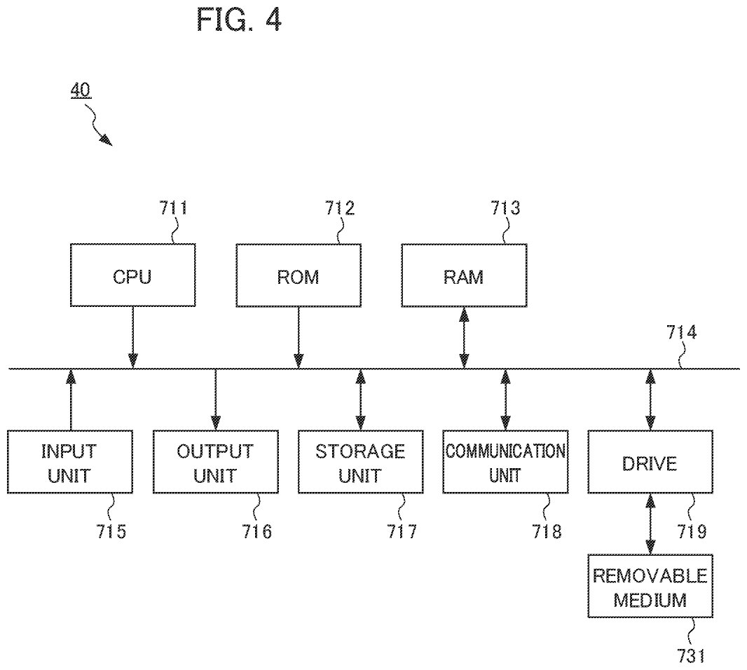

FIG. 4 is a schematic diagram illustrating a hardware configuration of the control device 40.

As illustrated in FIG. 4, the control device 40 includes a central processing unit (CPU) 711, read-only memory (ROM) 712, random-access memory (RAM) 713, a bus 714, an input unit 715, an output unit 716, a storage unit 717, a communication unit 718, and a drive 719.

The CPU 711 executes various types of processing following programs recorded in the ROM 712 or programs loaded to the RAM 713 from the storage unit 717.

The RAM 713 also stores data and so forth that is necessary for the CPU 711 to execute various types of processing, as appropriate.

The CPU 711, the ROM 712, and the RAM 713 are mutually connected via the bus 714. The input unit 715, the output unit 716, the storage unit 717, the communication unit 718, and the drive 719 are connected to the bus 714.

The input unit 715 includes an input device such as a mouse, a keyboard, or the like, and accepts input of various types of information directed to the control device 40. Note that a microphone may be included as the input unit 715, accepting input of various types of information by speech input by a worker.

The output unit 716 is made up of a display, a speaker, or the like, and outputs images or audio.

The storage unit 717 is made up of a hard disk, dynamic random-access memory (DRAM), or the like, and stores various types of data managed by various servers.

The communication unit 718 controls communication with other devices over a network.

A removable medium 731 such as a magnetic disk, an optical disc, a magneto-optical disk, semiconductor memory, or the like, is mounted to the drive 719 as appropriate. Programs read out from the removable medium 731 by the drive 719 are installed in the storage unit 717 as necessary.

Note that the above-described hardware configuration is a basic configuration of the control device 40, and that a configuration may be made in which part of the hardware is omitted, additional hardware is included, the form of implementation of the hardware is changed, or the like.

### [Functional Configuration]

Next, a functional configuration of the control device 40 will be described.

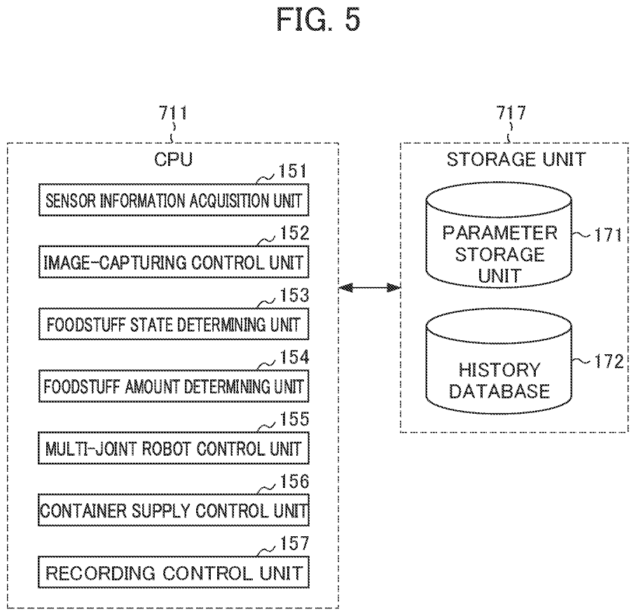

FIG. 5 is a block diagram illustrating the functional configuration of the control device 40.

As illustrated in FIG. 5, by executing programs for controlling actions of the portioning system 1, a sensor information acquisition unit 151, an image-capturing control unit 152, a foodstuff state determining unit 153, a foodstuff amount determining unit 154, a multi-joint robot control unit 155, a container supply control unit 156, and a recording control unit 157, function at the CPU 711 of the control device 40. Also, a parameter storage unit 171 and a history database 172 are formed in the storage unit 717.

Various types of parameters used for actions of the portioning system 1 are stored in the parameter storage unit 171. For example, parameters and so forth that define the position of the foodstuff container of the foodstuff supply unit 10, the position of the container for the packed meal supplied from the container supply unit 20, the position of a region in the container for the packed meal to which the foodstuff is to be packed, the relation between an insertion amount of the hand 31 into the foodstuff at the time of gripping the foodstuff and the weight of the foodstuff that is gripped (data in a function or table format, etc.), and action patterns of the multi-joint robot 30, are stored in the parameter storage unit 171. In the present embodiment, the insertion amount of the hand 31 into the foodstuff is an index for estimating the weight (physical quantity) of the foodstuff. That is to say, the actual weight of the foodstuff that is gripped (gripped weight that is a target) is estimated on the basis of the insertion amount of the hand 31 into the foodstuff, from the relation between the insertion amount of the hand 31 into the foodstuff and the weight of the foodstuff that is gripped.

The history database 172 stores parameters relating to control that are acquired during actions of the portioning system 1, or measurement data of the weight of foodstuff portioned out by the portioning system 1. The history database 172 also successively stores data of images shot in the process of actions of the portioning system 1.

The sensor information acquisition unit 151 acquires information (sensor information) detected by various types of sensors installed in the portioning system 1. For example, the sensor information acquisition unit 151 acquires data of the weight of foodstuff measured by the weight sensor 30A installed in the joint of the multi-joint robot 30, and data of the weight of foodstuff measured by the weight sensor 21 of the container supply unit 20.

The image-capturing control unit 152 controls the image-capturing device 33 so as to shoot images of the vicinity of the hand 31 of the multi-joint robot 30, images of the foodstuff of the foodstuff supply unit 10, images of the container for the packed meal, and so forth, at predetermined time intervals.

The foodstuff state determining unit 153 determines, from images of the foodstuff shot by the image-capturing device 33, the state of the foodstuff, on the basis of images of the foodstuff shot by the image-capturing device 33. For example, the foodstuff state determining unit 153 recognizes the depth of the foodstuff in the foodstuff container (the depth from the surface of the foodstuff in the foodstuff container to the bottom face of the foodstuff container), and the flatness of the surface (how rough the surface is). Note that it is sufficient to recognize at least the depth of the foodstuff at the position at which the hand 31 performs gripping. However, the depth of all of the foodstuff in the foodstuff container may be recognized. Also, the foodstuff state determining unit 153 determines whether or not the depth and flatness of the foodstuff meets conditions for gripping the foodstuff (e.g., whether or not the depth and flatness of the foodstuff are no less than threshold values that are set). Note that the surface flatness of the foodstuff can be defined on the basis of an absolute value of magnitude of roughness of the surface thereof or the like, for example, and can be defined such that the flatter the surface of the foodstuff is, the greater the value is. Also, the flatness may be determined for each of portions of the surface of the foodstuff. Moreover, the foodstuff state determining unit 153 determines whether or not the state of the foodstuff in the foodstuff container will allow the stipulated amount of foodstuff to be gripped by a single gripping action.

The foodstuff amount determining unit 154 determines whether or not the stipulated amount of foodstuff is gripped, and whether or not the stipulated amount of foodstuff is portioned into the container for the packed meal, on the basis of the data of weight of the foodstuff measured by the weight sensor 30A of the multi-joint robot 30, and the data of weight of the foodstuff measured by the weight sensor 21 of the container supply unit 20.

The multi-joint robot control unit 155 controls actions of the multi-joint robot 30, and causes the multi-joint robot 30 to execute a series of actions for portioning out the foodstuff in accordance with an action pattern defined in the portioning system 1. For example, the multi-joint robot control unit 155 causes the multi-joint robot 30 to perform an action of gripping the foodstuff by the hand 31 of the multi-joint robot 30, an action of transporting the foodstuff that is gripped to the container for the packed meal, an action of releasing the foodstuff that is gripped, an action of flattening the surface of the foodstuff in the foodstuff container (leveling action), an action of gathering together foodstuff in the foodstuff container (scraping action), and so forth.

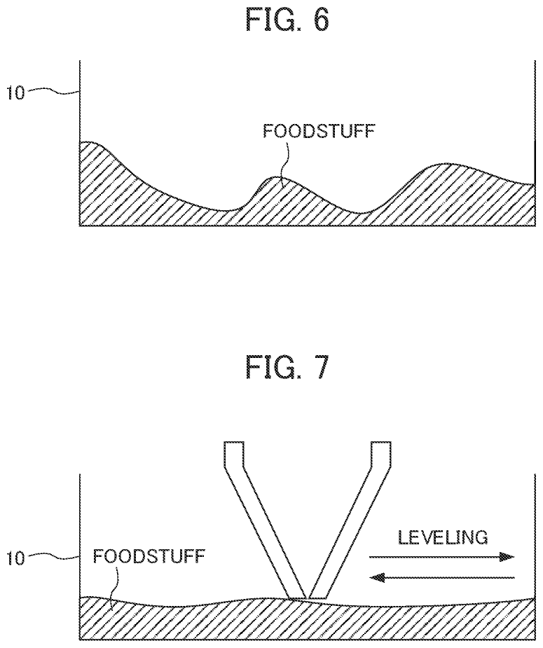

FIG. 6 is a schematic diagram illustrating an example of the state of foodstuff in the foodstuff container.

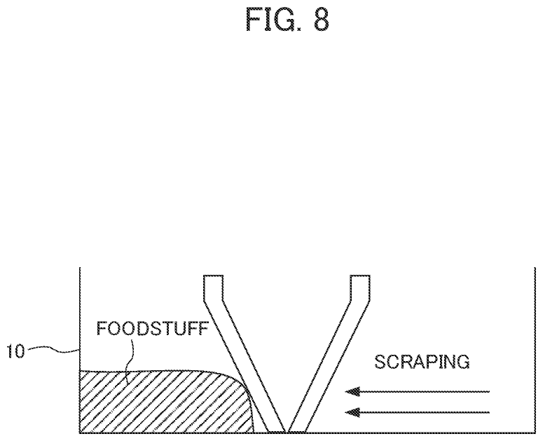

Also, FIG. 7 is a schematic diagram illustrating a concept of the leveling action, and FIG. 8 is a schematic diagram illustrating a concept of the scraping action.

As illustrated in FIG. 6, in a case in which the flatness of the surface of the foodstuff in the foodstuff container is low (rough), the multi-joint robot 30 performs the leveling action as illustrated in FIG. 7, thereby flattening the surface by the gripping members 31a. Note that in a case of performing the leveling action, the gripping members 31a can be moved at the same height from the bottom face of the foodstuff container with the distal ends of the gripping members 31a maintained in a state that is parallel with the bottom face of the foodstuff container, taking advantage of the fact that the distal ends of the gripping members 31a are flat (have linear edge portions). Also, in the leveling action, the outer faces of the gripping members 31a can be pressed against the foodstuff to flatten the foodstuff, or the outer faces of the gripping members 31a can be rubbed against the surface of the foodstuff to flatten the foodstuff, taking advantage of the fact that the outer faces of the gripping members 31a are flat.

Also, in a case in which the depth of the foodstuff in the foodstuff container is insufficient to perform the gripping action, as illustrated in FIG. 6, the multi-joint robot 30 performs the scraping action as illustrated in FIG. 8, to gather the foodstuff together by the gripping members 31a, to gain a sufficient depth for performing the gripping action. Note that besides gathering the foodstuff together by pressing the outer faces of the gripping members 31a against the foodstuff and moving the foodstuff as illustrated in FIG. 8, the foodstuff may be gathered together by gripping foodstuff by the gripping members 31a and stacking this foodstuff upon foodstuff at another portion.

The container supply control unit 156 controls the container supply unit 20 so as to supply the container for the packed meal, in which the foodstuff portioned out by the portioning system 1 is to be packed, to the packing position P1 at a predetermined timing. The container supply control unit 156 also controls the container supply unit 20 to discharge the container for the packed meal in which the foodstuff is packed to the conveyer belt 2.

The recording control unit 157 stores parameters relating to control acquired during actions of the portioning system 1, and measurement data of the weight of the foodstuff portioned out by the portioning system 1, in the history database 172. The recording control unit 157 also stores data of images shot in the process of actions of the portioning system 1 in the history database 172.

### [Specific Gripping Method of Foodstuff]

In the portioning system 1 according to the present embodiment, the relation between the depth of insertion of the hand 31 into the foodstuff (insertion amount) and the weight of the foodstuff that is gripped at that time is comprehended in advance, in accordance with the foodstuff and the type of hand 31 that is used. For example, by measuring density of the foodstuff that is gripped (a parameter representing weight per unit depth) in advance, the weight of the foodstuff that is gripped can be calculated (estimated) by a function in which a value obtained by multiplying the density of the foodstuff and the depth of inserting the hand 31 is an element. Accordingly, the weight of the foodstuff that is gripped can be estimated by simple computation. Also, the weight calculated in this way can be stored as data in a table format. Further, the range of the surface of the foodstuff at which the flatness decreases by one gripping operation can be comprehended, and accordingly a pitch of shifting the gripping position with each gripping action is set with respect to the surface of the foodstuff in the foodstuff container. Also, a basic action pattern is set regarding how the foodstuff will be gripped from which position of the surface of the foodstuff, on the basis of the depth of inserting the hand 31 and the pitch that are set in advance.

Note that as described above, in a case in which the flatness of the surface of the foodstuff in the foodstuff container does not meet conditions for gripping the foodstuff, the leveling action is performed, and the surface of the foodstuff is flattened. Also, in a case in which the depth of the foodstuff in the foodstuff container does not meet conditions for gripping the foodstuff, the scraping action is performed, and the foodstuff is gathered together.

In a case in which the flatness of the surface of the foodstuff and the depth of the foodstuff meet conditions for gripping the foodstuff, the gripping action is performed as follows, in accordance with a basic action pattern.

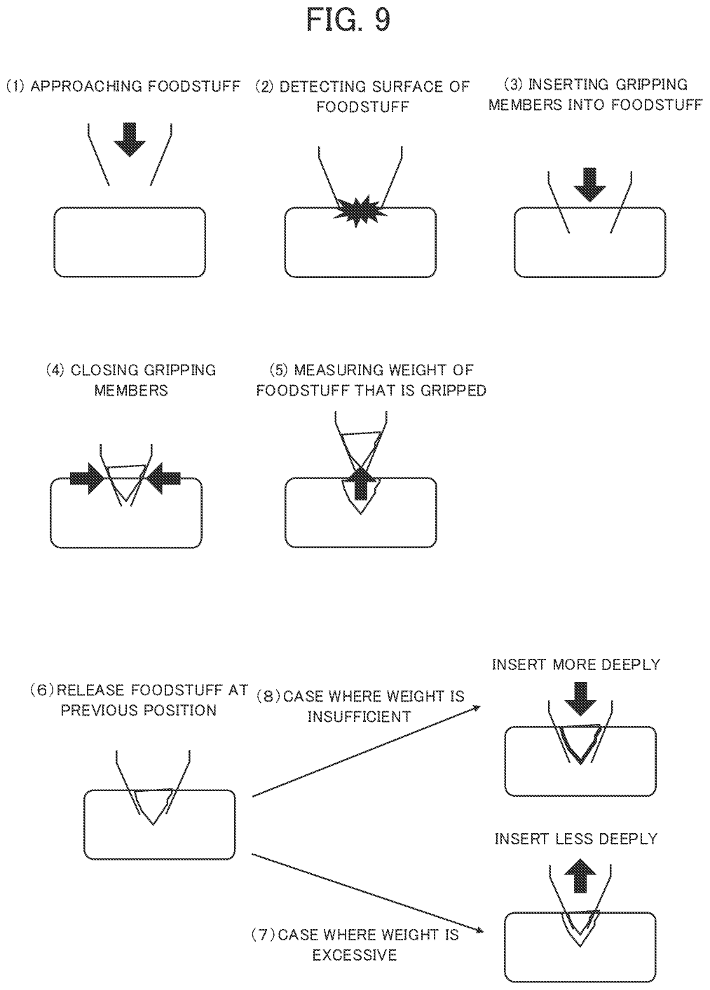

FIG. 9 is a schematic diagram illustrating an example of the gripping action performed by the hand 31.

As illustrated in FIG. 9, in a case of the hand 31 gripping the foodstuff, the foodstuff is gripped by procedures of (1) approaching the foodstuff, (2) detecting the surface of the foodstuff, (3) inserting the gripping members 31a into the foodstuff, (4) closing the gripping members 31a, and (5) measuring the weight (physical quantity) of the foodstuff that is gripped. In a case that the weight of the foodstuff that is gripped meets the stipulated amount, the foodstuff is transported to the container for the packed meal and released. Note that “the weight of the foodstuff that is gripped meeting the stipulated amount” means that, for example, the weight of the foodstuff that is gripped is within a predetermined margin (within ±15% or the like) with respect to a target weight. Note however, that the margin for a case in which the weight of the foodstuff that is gripped is greater than the stipulated amount may be set to be a larger margin than the margin for a case in which the weight of the foodstuff that is gripped is smaller than the stipulated amount, taking into consideration a situation in which the foodstuff adheres to the gripping members 31a and not all is released. On the other hand, further, in a case that the weight of the foodstuff that is gripped does not meet the stipulated amount, the foodstuff is regripped by the procedures of (6) releasing the foodstuff at the position in the foodstuff container from whence it was gripped (returning the foodstuff), (7) gripping the foodstuff with the depth of insertion of the gripping members 31a into the foodstuff corrected to be less deep than the previous time in a case in which the weight of the foodstuff that is gripped is excessive (e.g., in a case in which the weight of the foodstuff that is gripped exceeds the upper limit of the range of the stipulated amount), and (8) gripping the foodstuff with the depth of insertion of the gripping members 31a into the foodstuff corrected to be deeper than the previous time in a case in which the weight of the foodstuff that is gripped is insufficient (e.g., in a case in which the weight of the foodstuff that is gripped falls below the lower limit of the range of the stipulated amount).

In a case of detecting the surface of the foodstuff in procedure (2), the hand 31 of the multi-joint robot 30 can detect reactive force to which it is subjected by coming into contact with the foodstuff, or contact of the hand 31 with the surface of the foodstuff can be detected from images shot by the image-capturing device 33.

Also, in a case of inserting the gripping members 31a into the foodstuff in procedure (3), the insertion amount can be calculated from control parameters of the multi-joint robot 30 (rotational angle of the joint, etc.), or the insertion amount of the gripping member 31a can be estimated from images shot by the image-capturing device 33.

Also, in a case of releasing the foodstuff in procedure (6), depending on the type of foodstuff, the gripping members 31a may simply be opened to release the foodstuff, or following opening the gripping members 31a, the hand 31 may be caused to descend and then suddenly stop, to shake the foodstuff off, thereby releasing the foodstuff. Also, the action of shaking off the foodstuff may be repeatedly performed.

Also, in a case in which the stipulated amount of foodstuff cannot be gripped even when the gripping members 31a are inserted deeper into the foodstuff than the previous time (a case in which the depth of the foodstuff at the planned gripping position is shallower than the insertion depth necessary for obtaining the stipulated amount) and so forth in procedure (8), control may be performed to grip the foodstuff at a plurality of locations on the surface of the foodstuff, so that the total amount of the foodstuff that is gripped a plurality of times reaches the stipulated amount. In this case, for example, the total insertion depth of the gripping members 31a at the plurality of locations on the surface of the foodstuff (total insertion amount) can be controlled to be the same as the insertion depth of the gripping members 31a into the foodstuff in a case of gripping the stipulated amount of the foodstuff at a single time. Also, for example, in a case of gripping at second and subsequent locations, control may be performed such that the foodstuff that has already been gripped is temporarily released at the next planned gripping position, the gripping members 31a are inserted into the foodstuff at the surface of the foodstuff where the released foodstuff is present, to the insertion depth in a case of gripping the stipulated amount of the foodstuff at a single time, thereby gripping the stipulated amount of foodstuff again at a single time.

Note that besides calculating (estimating) the relation between the insertion depth (insertion amount) of the gripping members 31a into the foodstuff and the weight of the foodstuff that is gripped thereby from the density of the foodstuff, the weight of the foodstuff that is gripped may be estimated by performing machine learning of data regarding the depth of inserting the gripping members 31a and data measured regarding the weight of the foodstuff that is gripped thereby, and using a machine learning model generated by the machine learning. Also, the density of the foodstuff may be calculated in this process of machine learning, and the weight of the foodstuff that is gripped from the depth of inserting the gripping members 31a into the foodstuff (insertion amount) calculated, using the calculated density.

### [Actions]

Next, actions of the portioning system 1 will be described.

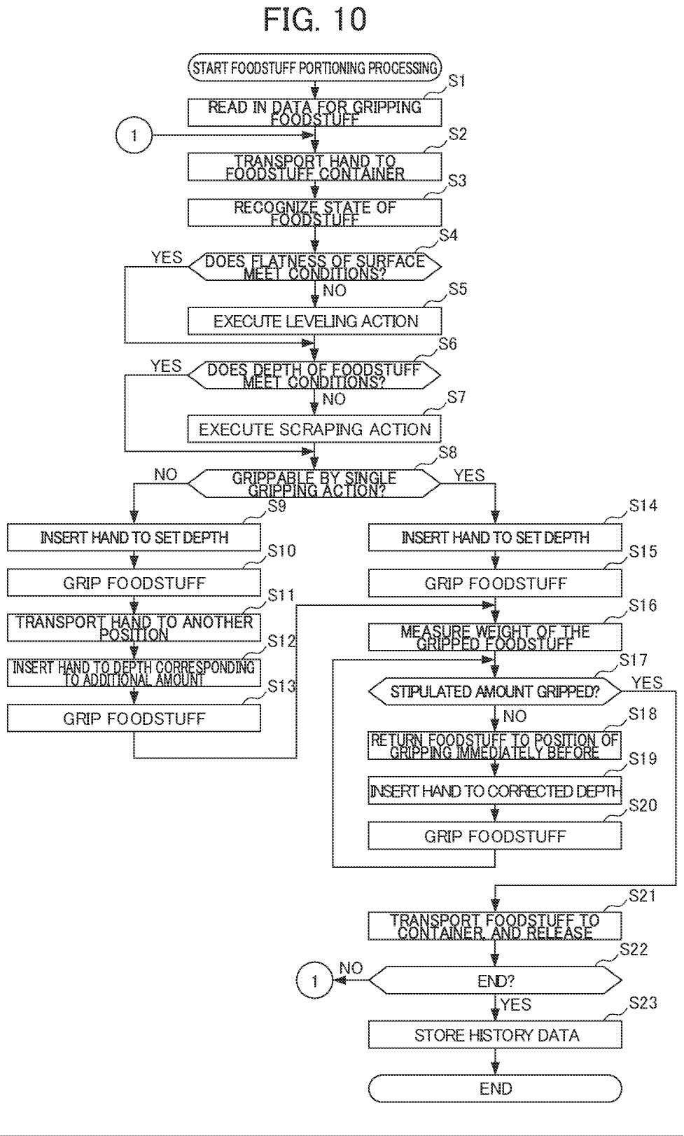

FIG. 10 is a flowchart showing the flow of foodstuff portioning processing executed by the portioning system 1.

When the foodstuff portioning processing is started, in step S1, the multi-joint robot control unit 155 reads in data for gripping the foodstuff (data for action patterns, data for insertion amount of hand 31, etc.)

In step S2, the multi-joint robot control unit 155 transports the hand 31 to the foodstuff container, in accordance with the data of the action patterns.

In step S3, the foodstuff state determining unit 153 recognizes the state of the foodstuff on the basis of images of the foodstuff shot by the image-capturing device 33.

In step S4, the foodstuff state determining unit 153 performs determination regarding whether or not the flatness of the surface of the foodstuff matches conditions for gripping the foodstuff.

In a case in which the flatness of the surface of the foodstuff does not meet conditions for gripping the foodstuff, determination of NO is made in step S4, and the processing transitions to step S5.

In a case in which the flatness of the surface of the foodstuff meets conditions for gripping the foodstuff, determination of YES is made in step S4, and the processing transitions to step S6.

In step S5, the multi-joint robot control unit 155 executes the leveling action to flatten the surface of the foodstuff.

In step S6, the foodstuff state determining unit 153 performs determination regarding whether or not the depth of the foodstuff in the foodstuff container meets conditions for gripping the foodstuff.

In a case in which the depth of the foodstuff in the foodstuff container does not meet conditions for gripping the foodstuff, determination of NO is made in step S6, and the processing transitions to step S7.

In a case in which the depth of the foodstuff in the foodstuff container meets conditions for gripping the foodstuff, determination of YES is made in step S6, and the processing transitions to step S8.

In step S7, the multi-joint robot control unit 155 executes the scraping action to gather the foodstuff together.

In step S8, the foodstuff state determining unit 153 determines whether or not the stipulated amount of foodstuff can be gripped by a single gripping action.

In a case in which the stipulated amount of foodstuff cannot be gripped by a single gripping action, determination of NO is made in step S8, and the processing transitions to step S9.

In a case in which the stipulated amount of foodstuff can be gripped by a single gripping action, determination of YES is made in step S8, and the processing transitions to step S14.

In step S9, the multi-joint robot control unit 155 inserts the hand 31 (gripping members 31a) to the depth set for the foodstuff.

In step S10, the multi-joint robot control unit 155 closes the gripping members 31a and grips the foodstuff.

In step S11, the multi-joint robot control unit 155 transports the hand 31 to another position (a position where the foodstuff is flat).

In step S12, the multi-joint robot control unit 155 inserts the hand 31 (gripping members 31a) to a depth of the foodstuff corresponding to an amount to be additionally gripped.

In step S13, the multi-joint robot control unit 155 closes the gripping members 31a and grips the foodstuff.

Following step S13, the processing transitions to step S16.

In step S14, the multi-joint robot control unit 155 inserts the hand 31 (gripping members 31a) to the depth set for the foodstuff.

In step S15, the multi-joint robot control unit 155 closes the gripping members 31a and grips the foodstuff.

In step S16, the foodstuff amount determining unit 154 measures the weight (physical quantity) of the foodstuff that is gripped.

In step S17, the foodstuff amount determining unit 154 determines whether or not the stipulated amount of foodstuff is gripped.

In a case in which the stipulated amount of foodstuff is not gripped, determination of NO is made in step S17, and the processing transitions to step S18.

In a case in which the stipulated amount of foodstuff is gripped, determination of YES is made in step S17, and the processing transitions to step S21.

In step S18, the multi-joint robot control unit 155 returns the foodstuff to the position of gripping immediately before.

In step S19, the multi-joint robot control unit 155 inserts the hand 31 into the foodstuff to a corrected depth.

In step S20, the multi-joint robot control unit 155 closes the gripping members 31a and grips the foodstuff.

Following step S20, the processing transitions to step S17.

In step S21, the multi-joint robot control unit 155 transports the foodstuff that is gripped to the position of the container for the packed meal, and releases the foodstuff at a predetermined region within the container. Upon the foodstuff being released at the predetermined region in the container, the foodstuff amount determining unit 154 determines whether or not the amount of foodstuff that is portioned out meets the stipulated amount. The result of this determination is associated with the container for the packed meal, and is handed over to processing downstream.

In step S22, the multi-joint robot control unit 155 determines whether or not conditions for ending the foodstuff portioning processing are met. As for conditions for ending the foodstuff portioning processing, a planned number of containers for packed meals being packed with foodstuff, an operation for ending the foodstuff portioning processing being performed, or the like, can be defined.

In a case in which conditions for ending the foodstuff portioning processing are not met, determination of NO is made in step S22, and the processing transitions to step S2.

In a case in which conditions for ending the foodstuff portioning processing are met, determination of YES is made in step S22, and the processing transitions to step S23.

In step S23, the recording control unit 157 stores parameters relating to control that are acquired in the foodstuff portioning processing, and measurement data of the weight of the foodstuff portioned out (history data) in the history database 172. Note that history data may be stored in the history database 172 each time the multi-joint robot 30 portions out the foodstuff to a container for a packed meal.

Following step S23, the foodstuff portioning processing ends.

As described above, the portioning system 1 according to the present embodiment is capable of calculating (estimating) the weight (physical quantity) of the foodstuff that is gripped, on the basis of the depth of inserting the gripping members 31a to the foodstuff.

Accordingly, performing the same gripping action by the multi-joint robot 30 enables foodstuff of an accurate amount to be portioned out, with variance thereof suppressed.

That is to say, according to the portioning system 1, work of portioning out foodstuff can be performed more appropriately by robots.

Also, according to the portioning system 1 of the present embodiment, the flatness of the surface of the foodstuff that is the object of gripping is recognized, and in a case in which the flatness of the surface of the foodstuff does not meet conditions for gripping the foodstuff, the leveling action for flattening the surface of the foodstuff is executed.

Accordingly, the gripping members 31a can be inserted into the foodstuff by a more accurate insertion amount, and thus the foodstuff can be portioned out more appropriately.

Also, according to the portioning system 1 of the present embodiment, in a case in which the depth of the foodstuff does not meet conditions for gripping the foodstuff, such as in a case in which the amount of foodstuff in the foodstuff container has decreased or the like, the scraping action of gathering the foodstuff in the foodstuff container together is executed.

Accordingly, even in a state in which there is little foodstuff, the foodstuff can be adjusted to a depth necessary for gripping thereof, whereby the foodstuff can be effectively utilized, and also the frequency of supplying the foodstuff can be reduced.

Hence, the work of portioning out foodstuffs by robots can be carried out more efficiently.

Also, according to the portioning system 1 of the present embodiment, in a case in which the stipulated amount of foodstuff cannot be gripped at once, the stipulated amount of foodstuff can be gripped by performing the gripping action a plurality of times.

Accordingly, in cases in which the amount of foodstuff in the foodstuff container decreases, cases in which portioning out foodstuff regarding which gripping the stipulated amount of foodstuff by gripping a single time is difficult, or the like, foodstuff of the weight that is necessary can be gripped through more flexible actions.

### [Modification 1]

Although an example is described in the above embodiment of using the gripping member 31a (FIG. 3) that has a form where side plates are provided on the right and left of a plate-like member of which the distal end is flat, this is not restrictive.

For example, in a case of portioning out foodstuff of which the proportion of solids is great, a gripping member 31a that has a form including claws on the distal end may be used.

A case of the gripping members 31a having such a form is advantageous in that the gripping members 31a can be inserted into the foodstuff more readily, by the claws pushing the solids away, and so forth. Also, at this time, inserting the gripping members 31a with the claws oblique to the surface of the foodstuff enables the gripping members 31a to be inserted more readily.

Note that the pair of gripping members 31a of the hand 31 may be made up of different types of gripping members 31a.

For example, one of the pair of gripping members 31a that the hand 31 has may have a form in which the distal end is flat (see FIG. 3), and the other may have a form with claws on the distal end.

In this case, the gripping action, the leveling action, or the scraping action can be performed by selecting gripping members 31a that have appropriate forms with respect to the state and so forth of the foodstuff.

### [Modification 2]

Although description is made in the above embodiment that the foodstuff state determining unit 153 recognizes the state of the surface of the foodstuff, and in a case in which the flatness of the surface of the foodstuff does not meet conditions for gripping the foodstuff, the leveling action is performed, this is not restrictive.

For example, a pitch of shifting the gripping position with respect to the surface of the foodstuff with each gripping action is set, and accordingly the leveling action may be performed after gripping the foodstuff from the entire surface of the foodstuff in the foodstuff container (i.e., each time the gripping action is performed a predetermined number of times).

In this case, the surface of the foodstuff can be adjusted to a state having a constant flatness, without detecting the state of the surface of the foodstuff by an image-capturing device or the like.

Note that a leveling action, performed each time the gripping action is performed a predetermined number of times, may be executed in conjunction with the leveling action according to the first embodiment.

### [Modification 3]

Although description is made in the above embodiment that the foodstuff state determining unit 153 recognizes the depth of the foodstuff, and the scraping action is performed in a case in which the depth of the foodstuff does not meet conditions for gripping the foodstuff, this is not restrictive.

For example, the amount of the foodstuff taken out from the surface of the foodstuff each time the gripping action is performed (depth of insertion of the gripping members 31a) is set, and accordingly the scraping action may be performed after gripping the foodstuff from the entire surface of the foodstuff in the foodstuff container (i.e., each time the gripping action is performed a predetermined number of times).

In this case, the foodstuff can be adjusted to a state of having constant depth, without detecting the depth of the foodstuff by an image-capturing device or the like.

Note that a scraping action, performed each time the gripping action is performed a predetermined number of times, may be executed in conjunction with the scraping action according to the first embodiment.

### [Modification 4]

Although an example is described in the above embodiment in which a stereo camera or an image-capturing device that shoots two-dimensional images is used as the image-capturing device, this is not restrictive.

For example, a depth camera that has functions of measuring distance (depth) to a subject can be used as the image-capturing device.

In this case, shooting a subject enables accurate depth information of each part to be easily acquired along with a color image.

Accordingly, three-dimensional forms of the foodstuff surface, the foodstuff container, and so forth, can be comprehended by the depth information of each portion.

This enables determining the flatness of the foodstuff surface and determining whether or not the leveling action is necessary, determining the depth of the foodstuff and determining whether or not the scraping action is necessary, and so forth.

### [Modification 5]

Although description is made in the above embodiment that the weight of the foodstuff that is gripped by the multi-joint robot 30, or the weight of the foodstuff portioned out to the container for the packed meal is measured by the weight sensors 30A and 21, this is not restrictive.

For example, the volume of the foodstuff can be estimated from images of the foodstuff shot by an image-capturing device, and the weight of the foodstuff can be calculated by multiplying the density and the estimated volume, or the like.

In this case, an arrangement for calculating the weight of the foodstuff can be implemented without using the weight sensors 30A and 21.

### [Modification 6]

Although description is made in the above embodiment that the flatness of the surface of the foodstuff is determined on the basis of images shot by an image-capturing device, this is not restrictive.

For example, the flatness of the surface of the foodstuff (how rough the surface is) can be determined by sense of force detected by the multi-joint robot 30 coming into contact with the surface of the foodstuff.

In this case, an arrangement for detecting the flatness of the surface of the foodstuff can be implemented without using an image-capturing device.

### [Modification 7]

Although description is made in the above embodiment that in a case of executing the leveling action, the gripping members 31a are moved at the same height from the bottom face of the foodstuff container with the distal ends of the gripping members 31a maintained in a state that is parallel with the bottom face of the foodstuff container, as illustrated in FIG. 7, this is not restrictive.

That is to say, in a case of executing the leveling action, various forms of actions capable of flattening the foodstuff surface can be executed.

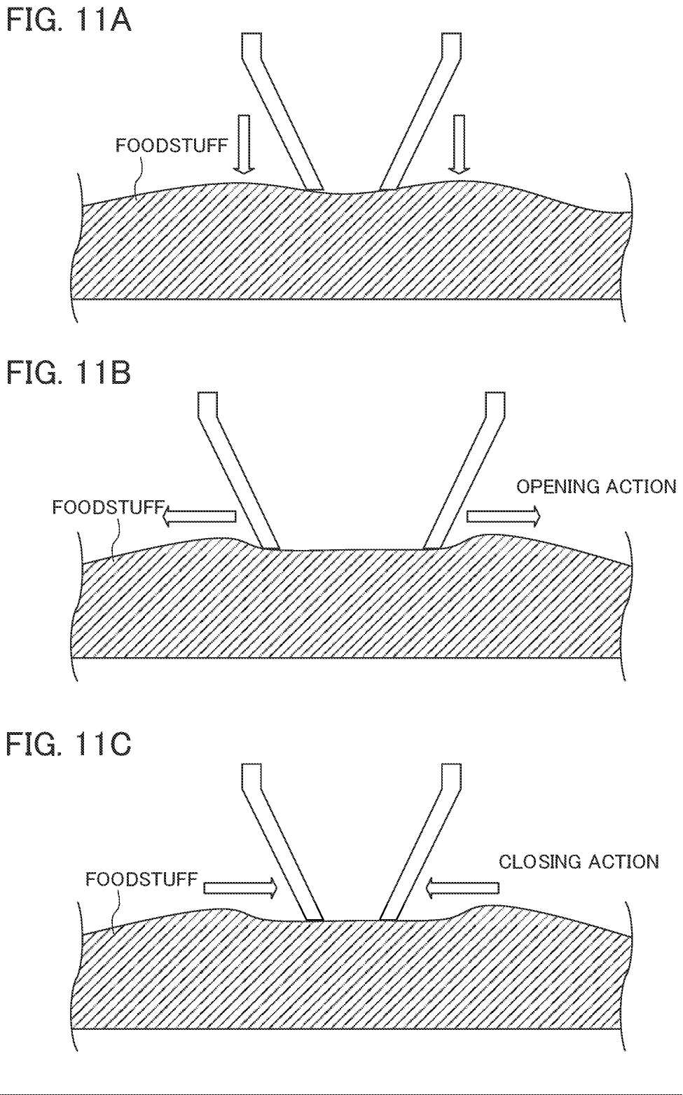

FIGS. 11A to 11C are schematic diagrams illustrating an example of another form of leveling action.

As illustrated in FIGS. 11A to 11C, in a case of executing this leveling action, in a state in which the distal ends of the gripping members 31a are in contact with the surface of the foodstuff (see FIG. 11A), actions of opening and closing the gripping members 31a (see FIG. 11B) are executed, and the foodstuff surface within the range of the opening and closing actions of the gripping members 31a can be flattened (see FIG. 11C).

In this case, the surface of the foodstuff positioned at the middle of the pair of gripping members 31a is flattened, and accordingly the position at which gripping the foodstuff next is planned can be flattened in a sure manner. Also, there is no need for an action to transport the hand 31 itself, and accordingly time required for the leveling action can be reduced.

### [Modification 8]

Although description is made in the above embodiment regarding an example in which, in a case of executing the scraping action, the foodstuff is gathered together by pressing the outer faces of the gripping members 31a against the foodstuff and moving the foodstuff as illustrated in FIG. 8, or an example in which the foodstuff is gathered together by gripping foodstuff by the gripping members 31a and placing this foodstuff upon other foodstuff, this is not restrictive.

That is to say, in a case of executing the scraping action, various forms of actions capable of gathering the foodstuff together can be executed.

For example, the form of at least one of the pair of gripping members 31a can be a form that is suitable for gathering the foodstuff together (a flat plate-like form or the like, as one example). In this case, when executing the scraping action, this gripping member 31a can be made to function as a scraping blade, to efficiently gather the foodstuff together.

### [Modification 9]

Although an example is described in the above embodiment in which the gripping members 31a included in the hand 31 of the multi-joint robot 30 is inserted to the foodstuff in the foodstuff supply unit 10 to a depth by which the physical quantity of the foodstuff is estimated to be a predetermined amount, thereby gripping a target amount of foodstuff, this is not restrictive.

That is to say, the amount of foodstuff that is gripped by the hand 31 can be adjusted by inserting the hand 31 into the foodstuff with the degree of opening thereof adjusted. For example, in a case in which the weight of the foodstuff that is gripped is excessive (e.g., a case in which the weight of the foodstuff that is gripped exceeds the upper limit of the range of the stipulated amount), the foodstuff can be gripped with the degree of opening of the hand 31 corrected to be narrower than the degree of opening the previous time when inserting the gripping members 31a into the foodstuff. Also, in a case in which the weight of the foodstuff that is gripped is insufficient (e.g., a case in which the weight of the foodstuff that is gripped falls below the lower limit of the range of the stipulated amount), the foodstuff can be gripped with the degree of opening of the hand 31 corrected to be wider than the degree of opening the previous time when inserting the gripping members 31a into the foodstuff, and so forth.

This enables the amount of foodstuff to be gripped to be adjusted even in cases in which the depth of insertion of the hand 31 into the foodstuff (insertion amount) cannot be adjusted.

### [Modification 10]

In the embodiment described above, the actions at the time of the hand 31 gripping the foodstuff may be adjusted to reflect the degree of ease of gripping the foodstuff.

For example, at the time of gripping the foodstuff by the hand 31, a phenomena can occur in which part of the foodstuff leaks (spills) from the hand 31, and is relocated to the surroundings of the gripping position.

Verification performed by the Inventors found that ease of spillage of the foodstuff differs depending on the position at which the hand 31 grips the foodstuff (i.e., the distance from the side walls or bottom of the foodstuff container, and so forth).

It was found that the orientation of the hand 31 affects the ease of spillage of the foodstuff by the walls in particular. Specifically, in a case in which there was a wall in the direction toward which foodstuff readily spills from the hand 31, the foodstuff had nowhere to go, and accordingly the ease of spillage decreased (i.e., the ease of gripping improved).

Taking this into consideration, the relationship between the two elements of the gripping position (i.e., distance from the walls and the bottom of the foodstuff container) and the orientation of the hand 31, and a parameter of the degree of ease of spilling (or ease of scooping) can be acquired by machine learning, and the depth of inserting the hand 31 (insertion amount) at the gripping position at which the hand 31 grips the foodstuff can be adjusted in accordance with the results thereof. For example, adjustment can be performed such that, at a gripping position at which the foodstuff easily spills, the depth of inserting the hand 31 into the foodstuff (insertion amount) can be set to be greater, or the like.

Thus, at the time of gripping the foodstuff by the multi-joint robot 30, more appropriate gripping operations can be performed in accordance with the situation.

As described above, a portioning system 1 according to the present embodiment includes a foodstuff supply unit 10, a multi-joint robot 30, and a control device 40.

The multi-joint robot 30 grips an object, which is a gripping object.

The control device 40 controls an action of the multi-joint robot 30.

The multi-joint robot 30, under control of the control device 40, inserts a gripping member 31a included in a hand 31 of the multi-joint robot 30 into the object, from a surface of the object to a depth at which a physical quantity of the object is estimated to be a predetermined amount, and grips the object.

Accordingly, performing the same gripping action by the multi-joint robot 30 enables foodstuff of an accurate amount to be gripped, with variance thereof suppressed.

That is to say, according to the portioning system 1, work of gripping the object can be performed more appropriately by robots.

The control device 40 estimates the depth of inserting the gripping member 31a into the object, from a target value of the physical quantity of the object to be gripped, on the basis of information relating to the physical quantity per unit depth (density, etc.) of the object. The physical quantity per unit depth preferably is measured by a worker in advance, or by acquiring an estimation value in advance on the basis of a relationship between insertion depth of the gripping member 31a and weight of the foodstuff that is gripped.

Accordingly, the weight of the foodstuff that is gripped can be estimated by simple computation.

The control device 40 causes the multi-joint robot 30 to execute a leveling action in which the surface of the object is flattened by the hand 31 of the multi-joint robot 30.

Accordingly, the gripping member 31a can be inserted into the foodstuff by a more accurate insertion amount, and thus the object can be gripped more appropriately.

The control device 40 determines a flatness of the surface of the object, and in a case in which the flatness does not meet a condition that is set, causes the multi-joint robot 30 to execute the leveling action.

Thus, in a case in which the surface of the object is not flat, the surface of the object can be adjusted to be flat, and the gripping member 31a can be inserted into the foodstuff by a more accurate insertion amount.

In a case in which the multi-joint robot 30 performs gripping of the object from the surface of the object a count of times that is set, the control device 40 causes the multi-joint robot 30 to execute the leveling action.

Thus, the surface of the object can be adjusted to a state having a constant flatness, without detecting the state of the surface of the object.

In the leveling action, the control device 40 flattens the surface of the object by causing the gripping member 31a to be opened and closed in a state in which a distal end of the gripping member 31a is in contact with the surface of the object.

Thus, the surface of the foodstuff positioned at the middle of the pair of gripping members 31a is flattened, and accordingly the position at which gripping the foodstuff next is planned can be flattened in a sure manner. Also, there is no need for an action to transport the hand 31 itself, and accordingly time required for the leveling action can be reduced.

The control device 40 causes the multi-joint robot 30 to execute a scraping action in which the object is gathered together by the hand 31 of the multi-joint robot 30.

Accordingly, the object can be effectively utilized, and also the frequency of supplying the object can be reduced.

The control device 40 determines a depth from the surface of the object accommodated in a container to a bottom face of the container, and in a case in which the depth from the surface of the object to the bottom face of the container does not meet a condition that is set, causes the multi-joint robot 30 to execute the scraping action.

Accordingly, even in a state in which there is little of the object, the object can be adjusted to a depth necessary for gripping thereof.

In a case in which the multi-joint robot 30 performs gripping of the object from the surface of the object a count of times that is set, the control device 40 causes the multi-joint robot 30 to execute the scraping action.

Accordingly, the object can be adjusted to a state having a constant depth, without detecting the depth of the object by an image-capturing device or the like.

The multi-joint robot 30 further includes a weight sensor 30A that acquires weight (a physical quantity) of the object that is gripped.

In a case in which the object that is gripped by the multi-joint robot 30 does not meet a stipulated amount, the control device 40 causes the object that is gripped to be released at a previous position in the foodstuff supply unit 10.

Accordingly, the object that is gripped once but is not an appropriate weight (physical quantity) can be returned to its previous position, and made to be the object of gripping again.

After the object that is gripped by the multi-joint robot 30 is released at the previous position in the foodstuff supply unit 10, the control device 40 corrects the depth at which the physical quantity of the object is estimated to be the predetermined amount, and causes the gripping member 31a of the multi-joint robot 30 to be inserted to the corrected depth and to perform regripping.

Accordingly, the object can be regripped at the corrected depth, and an appropriate amount of the object can be gripped again.

In a case in which the multi-joint robot 30 does not accomplish gripping the stipulated amount of the object by gripping a single time, the control device 40 causes the multi-joint robot 30 to perform gripping of the object from a different location in the foodstuff supply unit 10, and to perform gripping of the stipulated amount of the object by gripping a plurality of times.

Accordingly, in cases in which the amount of the object in the foodstuff container decreases, cases in which portioning out an object regarding which gripping the stipulated amount thereof by gripping a single time is difficult, or the like, the object of the weight that is necessary can be gripped through more flexible actions.

A distal end of the gripping member 31a has a form that is flat.

Accordingly, the leveling action can be performed more appropriately.

A distal end of the gripping member 31a has a form that includes a claw.

Accordingly, the gripping member 31a can be readily inserted to the foodstuff.

The hand 31 of the multi-joint robot 30 includes a plurality of gripping members 31a.

The plurality of gripping members 31a include a gripping member 31a that has a form that is different.

Accordingly, actions of the multi-joint robot 30 can be performed by selecting gripping members 31a having forms that are appropriate with respect to the state and so forth of the foodstuff.

Note that the above-described embodiments and modifications are examples of embodiments of the present invention, and various embodiments that realize the functions of the present invention are encompassed by the scope of the present invention.

For example, an example of applying the present invention to a portioning system for portioning out prepared foods has been described in the above embodiments and modifications, but the present invention can be applied to systems for gripping various objects. For example, the present invention can be applied to systems for gripping materials that are highly viscous or tacky, such as kneaded mortar, concrete, plaster, clay, and so forth. The present invention is suitable for gripping objects that have medium-level viscosity (5000 mPa·s) or higher viscosity at working temperature or room temperature.

The present invention can be carried out combining examples described in the above embodiment as appropriate.

The processing sequence described above can be executed by hardware, and can also be executed by software.

In other words, the functional configuration in FIG. 5 is only exemplary, and is not restrictive in particular. That is to say, it is sufficient for the portioning system 1 to include functions capable of executing the entire series of processing described above, and what sort of functional blocks are used to realize these functions are not limited to the example in FIG. 5.

A single functional block may be configured by a single piece of hardware, a single installation of software, or a combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium storing the program is made up of removable media that is distributed separately from the apparatus main unit, or storage media or the like that is built into the apparatus main unit in advance. Examples of the removable media include magnetic disks, optical discs, magnetooptical disks, flash memory, and so forth. Examples of optical disks include compact disc read-only memory (CD-ROM), Digital Versatile Discs (DVD), Blu-ray discs (registered trademark), and so forth. Examples of magnetooptical disks include MiniDiscs (MD) and so forth. Examples of flash memory include Universal Serial Bus (USB) memory and Secure Digital (SD) cards. Also, examples of storage media built into the apparatus main unit in advance include ROM, hard disks, and so forth, in which programs are stored.

It should be noted that, in the present specification, the steps describing the program recorded in the storage medium include not only the processing executed in a time series following this order, but also processing executed in parallel or individually, which is not necessarily executed in a time series.

Further, in the present specification, the terminology of the system means an entire apparatus including a plurality of apparatuses and a plurality of units.

The above embodiment is an example to which the present invention is applied, and does not limit the technical scope of the present invention. That is, the present invention may be subjected to various modifications such as omission and replacement without deviating from the spirit of thereof, and various embodiments other than that described above may be implemented. Various embodiments and modifications thereof that can be implemented in the present invention are included in the scope of the invention described in the claims and an equivalent scope.

What is claimed is:

1. A gripping system, comprising:
a robot that grips an object, which is a gripping object; and
a control device that controls an action of the robot,
wherein
the robot, under control of the control device, inserts a gripping member included in a hand of the robot into the object, from a surface of the object to a depth at which a physical quantity of the object is estimated to be a predetermined amount, and grips the object.

2. The gripping system according to claim 1, wherein
the control device estimates the depth of inserting the gripping member into the object, from a target value of the physical quantity of the object to be gripped, on the basis of information relating to the physical quantity per unit depth of the object.

3. The gripping system according to claim 1, wherein
the control device causes the robot to execute a leveling action in which the surface of the object is flattened by the hand of the robot.

4. The gripping system according to claim 3, wherein
the control device determines a flatness of the surface of the object, and in a case in which the flatness does not meet a condition that is set, causes the robot to execute the leveling action.

5. The gripping system according to claim 3, wherein,
in a case in which the robot performs gripping of the object from the surface of the object a count of times that is set, the control device causes the robot to execute the leveling action.

6. The gripping system according to claim 3, wherein,
in the leveling action, the control device flattens the surface of the object by causing the gripping member to be opened and closed in a state in which a distal end of the gripping member is in contact with the surface of the object.

7. The gripping system according to claim 1, wherein
the control device causes the robot to execute a scraping action in which the object is gathered together by the hand of the robot.

8. The gripping system according to claim 7, wherein
the control device determines a depth from the surface of the object accommodated in a container to a bottom face of the container, and in a case in which the depth from the surface of the object to the bottom face of the container does not meet a condition that is set, causes the robot to execute the scraping action.

9. The gripping system according to claim 7, wherein,
in a case in which the robot performs gripping of the object from the surface of the object a count of times that is set, the control device causes the robot to execute the scraping action.

10. The gripping system according to claim 1, wherein
the robot further includes a physical quantity acquisition unit that acquires a physical quantity of the object that is gripped, and
in a case in which the object that is gripped by the robot does not meet a stipulated amount, the control device causes the object that is gripped to be released at a previous position.

11. The gripping system according to claim 10, wherein,
after the object that is gripped by the robot is released at the previous position, the control device corrects the depth at which the physical quantity of the object is estimated to be the predetermined amount, and causes the gripping member of the robot to be inserted to the corrected depth and to perform regripping.

12. The gripping system according to claim 1, wherein,
in a case in which the robot does not accomplish gripping the stipulated amount of the object by gripping a single time, the control device causes the robot to perform gripping of the object from a different location, and to perform gripping of the stipulated amount of the object by gripping a plurality of times.

13. The gripping system according to claim 1, wherein
a distal end of the gripping member has a form that is flat.

14. The gripping system according to claim 1, wherein
a distal end of the gripping member has a form that includes a claw.

15. The gripping system according to claim 1, wherein
the hand of the robot includes a plurality of gripping members, and
the plurality of gripping members include the gripping member that has a form that is different.

16. A gripping method, executed by a gripping system that includes a robot, the method comprising:
gripping of an object, which is a gripping object, by the robot, wherein,
in the gripping, the robot inserts a gripping member included in a hand of the robot into the object, from a surface of the object to a depth at which a physical quantity of the object is estimated to be a predetermined amount, and grips the object.

17. A non-transitory storage medium storing a program that causes a computer controlling a robot to
execute a gripping processing of gripping an object, which is a gripping object, wherein
the gripping processing is inserting a gripping member included in a hand of the robot into the object, from a surface of the object to a depth at which a physical quantity of the object is estimated to be a predetermined amount, and gripping the object.
